(19) United States
(12) Patent Application Publication
(10) Pub. No.: US 2012/0234394 A1
(43) Pub. Date: Sep. 20, 2012

(54) LIQUID AERATOR

(75) Inventors: Jurl Seletzky, Oakland, CA (US); Joerg Kauling, Bergisch Gladbach (DE); Björn Frahm, Lemgo (DE); Helmut Brod, Koln (DE); Marc Jenne, Leverkusen (DE); Franz Schmitt, Bad Kissingen (DE)

(73) Assignee: BAYER TECHNOLOGY SERVICES GMBH, Leverkusen (DE)

(21) Appl. No.: 13/395,721

(22) PCT Filed: Sep. 4, 2010
(86) PCT No.: PCT/EP2010/005442

§ 371 Date: May 30, 2012

(30) Foreign Application Priority Data
Sep. 18, 2009 (DE) 10 2009 042 200.5

(51) Int. Cl. B01F 3/04; B01F 5/04

(52) U.S. Cl. 137/3; 261/75

(57) ABSTRACT

The invention relates to a sparger for introducing a gas or gas mixture into a liquid and to a method for sparging liquids. The sparger according to the invention comprises a cavity, a gas inlet for routing a gas into the cavity and two or more faces, which are or can be pressed onto one another in a positive fashion such that a gas pressed into the cavity through the gas inlet escapes through the gaps occurring between the pressed together faces.

The invention relates to a sparger for introducing a gas or gas mixture into a liquid, preferably in the form of microbubbles, and to a method for sparging liquids.

Sparging liquids with a gas or gas mixture plays a very important role in a multiplicity of technical applications. Supplying cells or organisms in a liquid culture medium with oxygen is mentioned in an exemplary, but non-restrictive, fashion.

Depending on the application, there are very different demands on the sparging system. Thus, cultivating human, animal or plant cells in a culture medium is very challenging, because, in contrast to microorganisms, the cells are very sensitive to mechanical shear stresses and insufficient supply of oxygen and nutrients (see e.g. H.-J. Henzler: “Particle Stress in Bioreactors” Adv. Biochem. Eng./Biotechnol. 67 (2000), pp. 35-82).

In contrast to nutrients that are present in the culture medium at concentrations which do not need constant replenishing, the oxygen solubility of the culture medium is often so low that the cells would rapidly suffer from oxygen shortage without a continuous oxygen supply. In addition to an adequate oxygen supply, the removal of carbon dioxide is of similar importance.

It is known (see e.g. EP0422149B1) that strong shear forces act during the creation and bursting of gas bubbles and these could lead to cell damage. This reduces the yield. Moreover, components of destroyed cells lead to product contamination and more difficult processing (cleaning).

Furthermore, gas bubbles lead to the formation of foam. However, the formation of foam should be avoided because cells tend to float with the foam. They do not find adequate cultivation conditions in the layer of foam. The use of anti-foam agents can lead to cell damage or a loss in yield during the processing or to an increased processing effort. Moreover, an adequate oxygen supply can only be ensured up to relatively low cell densities in the case of a large-bubble sparging method and shear-sensitive cells. (H.-J. Henzler: “Verfahrentechnische Auslegungsunterlagen für Rührbehälter als Fermenter” [“Process design documentation for agitator vessels as fermenter”] Chem. Ing. Tech. 54 (1982) No. 5, pp. 461-476).

Bubble-free sparging avoids this problem by allowing the gas exchange to take place over an immersed membrane face. Here, sparging is performed with closed or open-pore membranes. By way of example, these are arranged in the liquid moved by a stirrer. By way of example, the membranes can be wound onto cylindrical cage stators (EP0172478B1, EP0240560B1) as tubes. The tubes are packed together closely with as little spacing as possible in order to house large mass exchange surfaces. Silicone has established itself over porous polymers as tube material. However, dead spaces between the tubes and between the stator and the tubes, in which deposits can easily form, have been found to be problematic. The increasing deposition of substances on the silicone tubes themselves leads to an increasingly poorer gas transfer, e.g. for supplying cells with oxygen or removing carbon dioxide.

Moreover, the comparatively low mass transport coefficient is disadvantageous in the above-described membrane sparging (H.-J. Henzler, J. Kauling: “Oxygenation of cell cultures” Bioprocess Engineering 9 (1993), pp. 61-75). In order to achieve high mass transport rates it is necessary to install a correspondingly large membrane face in the bioreactor. However, this is complex in terms of the design and handling (assembly, sterilization, cleaning, creation of insufficiently-well mixed regions, etc.) and leads to an enlargement of dead spaces. It is feasible to increase the power input. Since the mass transport coefficient depends on the power input, this can bring about an increase in the mass transport rate. However, the potential is restricted by the resulting shear load applied to the cells as a result of the higher power input. Cleaning the membrane tubes is difficult, and so, in production, all membrane tubes are generally completely replaced after each cultivation. To this end, the membrane stator needs to be extracted from the bioreactor which, in the case of a reactor volume greater than approximately 100 l, in turn requires the use of a crane, pulley or corresponding device.

A further option is provided by microbubble sparging, in which gas can be introduced into a liquid in the form of fine bubbles and/or a gas can be removed from the liquid. Here “fine bubbles” are understood to mean gas bubbles with a small diameter, for example less than 1 mm. Furthermore, the gas bubbles should have a low tendency to coalesce in the utilized culture medium. Such small bubbles are created by gas being pressed through e.g. special sintered bodies made of metallic or ceramic materials, filter plates or laser-perforated plates, which have pores or holes with a diameter of generally less than 100 μm. The membrane faces are preferably embodied as hollow bodies, e.g. pipes, through which gas can flow (see e.g. D. Nehring, P. Czermak, J. Vorlop, H. Lübben: “Experimental study of a ceramic micro sparging aeration system in a pilot scale animal cell culture” Biotechnology Progress 20 (2004), pp. 1710-1717). However, sintered bodies have dead spaces, in which there may be deposits/corrosion and fouling or the like. During long-term operation, deposits/corrosion and fouling or the like often occur not only in dead spaces, but generally on the sparger surface as well. Depending on the operating conditions and utilized medium, or contents thereof, this may for example occur only after approximately 10 days. Sintered bodies easily tend to being blocked, i.e. there is a decrease in the sparging quality over time and this can have grave consequences for cultivated cells. Sintered bodies cannot be produced in a reproducible fashion, i.e. they have variable properties in respect of e.g. the oxygen transfer coefficient or the bubble size distribution. Sintered bodies can only be cleaned with great difficulties. Furthermore, in the case of given sintered bodies, the sparging properties can only be regulated by means of the gas pressure. There is no option for setting the bubble size and the introduced amount of gas independently of one another in the case of a given sintered body.

Proceeding from the above-described prior art, it is therefore an object to provide a sparging system that does not have the above-described disadvantages. It is an object to provide a sparging system that produces bubbles with desired sizes independently of the volume flow or system pressure. In particular, the sought-after sparging system should be able to create microbubbles. In the process, it should be easy and intuitive to handle, cost-effective in production and use, and simple to clean when required. It should be producible as a preferred embodiment for single use (disposable article). It should have negligible dead spaces such that if the sought-after sparging system is used in fermentation there is no fouling. The sought-after sparging system should ensure constant sparging for the whole duration. The sought-after sparging system should be utilizable when cultivating shear-sensitive cells.

Surprisingly it was found that bubbles and, in particular, microbubbles could be created in a liquid by pressing a gas through the gaps between faces pressed onto one another in a positive fashion.

Thus, a first object of the present invention is a sparger for liquids, at least comprising a cavity, a gas inlet for routing a gas into the cavity and two or more faces, which are or can be pressed onto one another in a positive fashion such that a gas pressed into the cavity through the gas inlet escapes through the gaps occurring between the pressed together faces.

The liquid sparger according to the invention comprises at least two faces, which can be brought into positive contact and can be pressed onto one another. The faces can be planar or bent or wavy or serrated or have any other imaginable shape. The positive contact affords the possibility of creating a uniform (homogeneous) gap between respectively two faces through which a gas or gas mixture can be pressed.

The positive contact between respectively two faces prevents isolated channels, which can lead to uncontrollable sparging conditions such as e.g. short-circuit flows, from occurring between the pressed together faces. Such isolated channels cause the gas to be introduced into the liquid primarily over the channels. However, it is a goal to distribute a gas or gas mixture, which was pressed into a hollow body of the sparger according to the invention via a gas inlet, uniformly over one or more well-defined homogeneous gaps between the faces that are in contact in a positive fashion. If the sparger according to the invention is immersed into a liquid and gas is pressed into the hollow body, said gas homogeneously emerges from the sparger into the liquid along the lengths of the gaps and forms bubbles in the liquid.

In a preferred embodiment, the faces that are in contact are planar. The planar embodiment can be implemented in a particularly simple fashion and pressing the planar faces onto one another yields uniform, well-defined gaps between the faces.

In a preferred embodiment, the faces are provided by annular discs. Two or more annular discs are stacked one above the other such that the cut-outs in the centre of the annular discs form a contiguous cavity (see e.g. FIG. 1). If the stack of annular discs is sealed at the top and bottom and a gas inlet, leading into the cavity, is attached, a gas can be pressed into the cavity and escape through the gaps between the annular discs.

In a further preferred embodiment the faces are provided by the windings of a helical spring. In this case the faces to be brought into positive contact are not provided by separate bodies as in the case of a stack of annular discs, but they are part of a single body that is shaped such that part of the surface thereof can be brought into contact with another part of the surface thereof in a positive fashion. A helical spring as a surface element of a plate sparger according to the invention is advantageous in that the individual faces (windings) are already arranged with respect to one another such that it is possible to bring them into contact with one another easily by applying a force onto the helical spring and it is possible to press them onto one another in a positive fashion. In the process, the helical spring exerts an opposing force on the external force that presses the spring together, and so the gap width between the faces (windings) can be set in a controlled fashion by the external force. This allows a variable bubble-size setting.

In a preferred embodiment, the bodies that provide the faces to be pressed onto one another in a positive fashion are at least partly deformable such that the bodies “nestle” against one another as a result of an external contact pressure and form a positive contact.

The sparger according to the invention is preferably embodied such that gas, which escapes to the outside from the interior of the sparger according to the invention through the gaps between the faces that are pressed onto one another in a positive fashion, is introduced into the liquid in a uniform fashion over the entire outwardly directed gap circumference. To this end, the faces are preferably embodied symmetrically as in the case of the annular discs. In the following text, the bodies that support the faces to be pressed onto one another in a positive fashion are also referred to as face-supporting bodies or, for short, as plates. Accordingly, an annular disc and a helical spring are specific embodiments of a plate that has faces that can be brought into positive contact either with the faces of another plate (as in the case of the annular discs) or with other faces of the same plate (as in the case of the helical spring), and can be pressed onto one another.

Plates can be solid or porous; use is preferably made of solid plates. By way of example, the plates can consist of metal, plastic, glass, ceramics or a composite material. The material of which use is preferably made is high-grade steel (e.g. stainless [VA] steel) or plastic (e.g. Teflon, PMMA).

It is feasible to use plates made of different materials in a sparger. By way of example, it is feasible to alternately use plates made of two different materials in a stack of annular discs.

The sparger according to the invention is easy to clean. By way of example, to this end it can be taken apart and the faces can be cleaned by mechanical wear. The preferably planar faces are easily accessible for cleaning purposes; there are no dead spaces that would be difficult to clean.

However, it is also feasible to embody the sparger according to the invention such that cleaning is possible during operation. By way of example, it is feasible to displace the faces pressed onto one another briefly with respect to one another, or to lift these apart, and thus undertake cleaning of the gaps. This displacement or lifting of the faces leads to the removal of accumulated substances and is optionally supported by a briefly increased emergent gas volume flow (“purge”).

FIG. 5 illustrates a preferred embodiment of a sparger according to the invention, in which cleaning takes place during operation by means of a pressure pulse, during which the faces are briefly lifted away from one another (see description below).

As a result of the simple and cost-effective production of the sparger according to the invention, it is also possible to embody the latter as a disposable article. The sparger is embodied as a disposable article in a preferred embodiment.

The sparger according to the invention unifies a number of advantages over the sparging systems known from the prior art. It allows the production of microbubbles, and so it can be used for cultivating shear-sensitive cells. In the process, it is easy to install and operate. It can easily be cleaned, or can be embodied as a disposable article. Here, it is cost-effective in production and use. The sparger according to the invention carries out uniform and, over the operation, constant sparging; blockages or fouling do not occur.

The sparger according to the invention can have a multiplicity of uses. In particular, it is suitable for supplying cells and organisms with gaseous nutrients (e.g. oxygen) and disposing of gaseous metabolites (e.g. carbon dioxide). Therefore the subject matter of the present invention is also the use of the sparger according to the invention for sparging culture media (cells and/or organisms in a preferably aqueous suspension).

The subject matter of the present invention furthermore relates to a method for sparging liquids with a gas or gas mixture. The method according to the invention is characterized in that a gas or gas mixture is routed between two or more faces pressed onto one another in a positive fashion and introduced into the liquid via the gaps between the faces.

The positive pressing onto one another of the faces (face pressing) can, as a person skilled in the art is well aware, be brought about by forces that act in opposite directions on the bodies supporting the faces. By way of example, the forces can be generated by springs and/or screws. The advantage of such a method lies in the fact that the forces for pressing onto one another can be set and hence the force constitutes a controlled variable for setting the bubble size (see below).

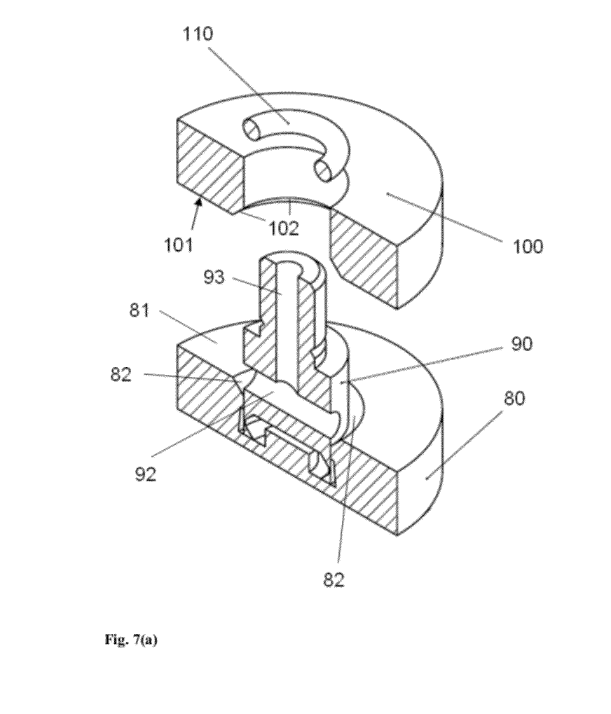

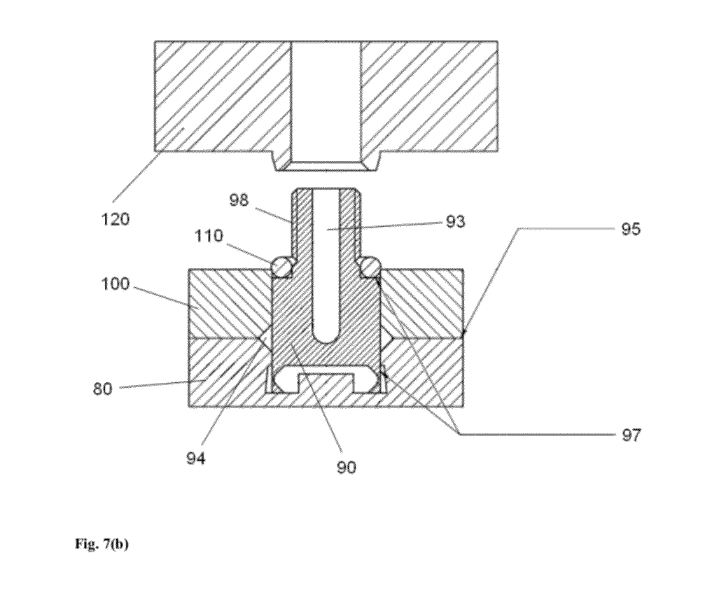

A further option consists of the single pressing of plates during the production of the sparger according to the invention. This results in fixedly set, permanently acting forces. In constructional terms, this can for example be implemented by virtue of the fact that a pin is upset in a cavity such that the applied pressing forces can be permanently maintained (see FIGS. 7, 8 and 9). Another option consists of pressing conical components into one another. An advantage of the single pressing of plates during production and the fixedly set, permanently produced forces resulting therefrom lies in a simple construction, which preferably permits low production costs in the case of a single use (disposable) plate sparger. A further advantage lies in the low installation height. The disadvantage of not being able to set the forces after production anymore can be circumvented by the production of a number of disposable variants with plates pressed together to a different extent. Thus, for example, a range of single use (disposable) plate spargers with plates pressed together to a different extent can be kept in stock for different bubble sizes/uses.

The sparging properties of the sparger according to the invention, i.e. the bubble size and the amount of gas introduced into a liquid, can be set in a versatile fashion via parameters such as number of plates, material combination of the plates, surface properties (shape, roughness), contact pressure of the faces, gap lengths and gap widths, and gas system pressure.

The parameters are preferably selected such that microbubbles are created when gas is pressed through the face gaps. Microbubbles are understood to mean bubbles that have a diameter of less than 1 mm. Microbubbles preferably have a diameter of less than 500 μm, particularly preferably of less than 200 μm and very particularly preferably of less than 100 μm. Compared to larger bubbles, microbubbles have a larger ratio between bubble surface and volume thereof Microbubbles therefore allow better mass transport from the gaseous to the liquid phase and thus, e.g. in the case of fermentation, accordingly allow higher cell concentrations or productivities or space/time yields than larger bubbles.

The parameters for creating microbubbles depend on the respective application and can easily be established empirically using routine trials (see below). The parameters are particularly preferably set such that microbubbles are created that have a diameter of less than 100 μm. In a particularly preferred embodiment of the method according to the invention, microbubbles are created with a diameter in the range of between 10 μm and 80 μm, preferably of between 20 μm and 60 μm. Examples of parameter combinations that yield microbubbles are listed below. By way of example, the size of the created bubbles can be measured optically by means of laser scattering.

### EXAMPLES

The invention will be explained in more detail below on the basis of figures and examples, without being restricted thereto.

The embodiments, which are shown and described in the examples, and the features thereof can also be combined amongst one another.

### LIST OF REFERENCE SIGNS

1 Face-supporting body/plate

1a Face-supporting body/plate

1b Face-supporting body/plate

1c Annular disc

1d Intermediate disc

2 Homogeneous gap between two faces pressed onto one another in a positive fashion

3 Gas bubbles

5 Cavity

10 Gas inlet for sparging

15 Threaded rods

16 Nuts

17 Holder

18 Seals

20 Base body

21 Cup springs

30 Cleaning unit

31 Cup springs

40 Control air for cleaning unit

50 Lower body

51 Planar face

52 Cavity

54 Gas inlet

57 Feed through

60 Intermediate disc

61a Planar face

61b Planar face

62 Openings

66 Recessed region

67 Feed through

70 Cover

71 Planar face

77 Female thread

80 Lower plate

81 Planar face (annular)

82 Chamfer

90 Connection bolt

92 Channel

93 Channel

94 Channel with annular profile

95 Annular gap

100 Upper plate

101 Planar face (annular)

102 Chamfer

105 Intermediate discs

110 O-ring gasket

120 Pressing tool

200 Immersion pipe

300 Connecting piece

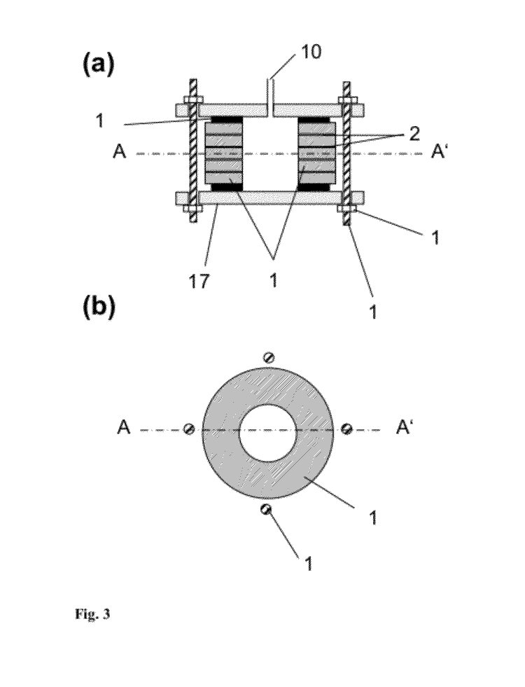

FIG. 1 schematically shows three annular discs (1c), which are pressed onto one another by means of forces directed in opposite directions (symbolized by the dashed arrows). The annular discs have a planar design such that their planar faces can be brought into contact in a positive fashion without isolated channels occurring between the faces pressed onto one another in a positive fashion, through which channels a gas could escape in an uncontrolled fashion. There is a cavity 5 within the annular discs, to which gas can be applied by means of a corresponding gas inlet if the annular-disc stack is suitably sealed at the top and bottom (see e.g. FIG. 3). The gas pressed into the cavity 5 is distributed homogeneously over all gaps and emerges homogeneously over the full gap lengths. When inserting the sparger according to the invention into a liquid, this affords the possibility of creating microbubbles in the liquid and hence an effective and sparing sparging.

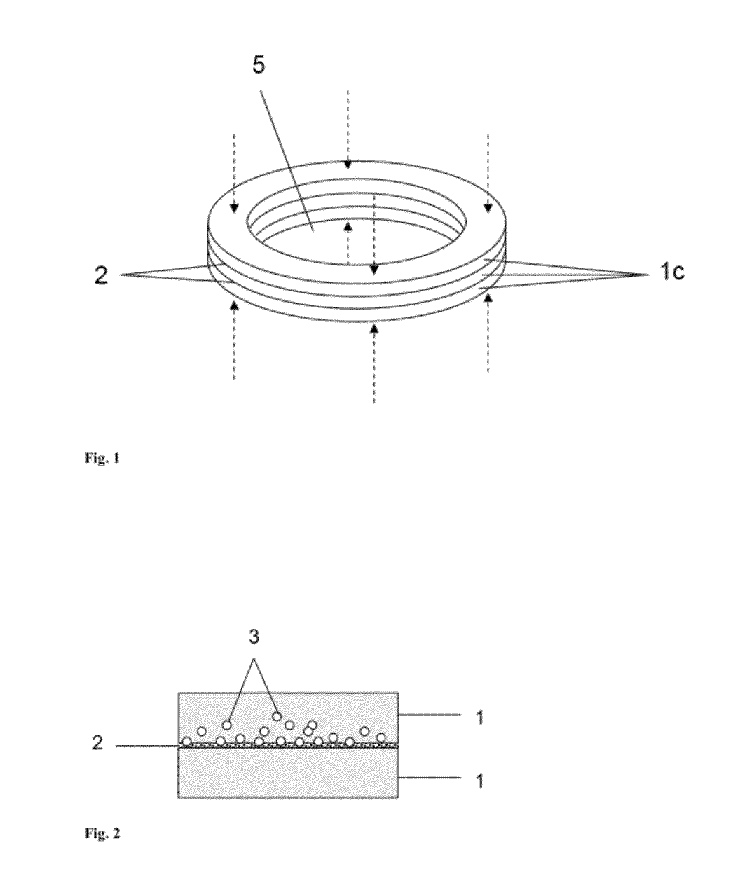

FIG. 2 schematically shows an enlarged lateral section of faces (1a, 1b) pressed onto one another. The gap 2 between the plates is uniform over the entire region, and so gas can be introduced uniformly into the liquid over the extent of the gap directed into the liquid, in which liquid said gas forms bubbles 3.

FIG. 3 schematically shows a preferred embodiment of a sparger according to the invention. It comprises planar annular discs 1, which are clamped into a holder 17 by means of threaded rods 15 and nuts 16. The contact pressure of the annular discs can be set via the torque on the nuts 16. The stack of annular disks is sealed with respect to the holder by means of seals 18. Gas is pressed into the sparger via a gas inlet 10 and it can, preferably in the form of microbubbles, escape into a liquid via the gaps 2 between the annular discs. FIG. 3(a) shows the described sparger according to the invention in a lateral view and FIG. 3(b) shows a cross section between the points A and A′.

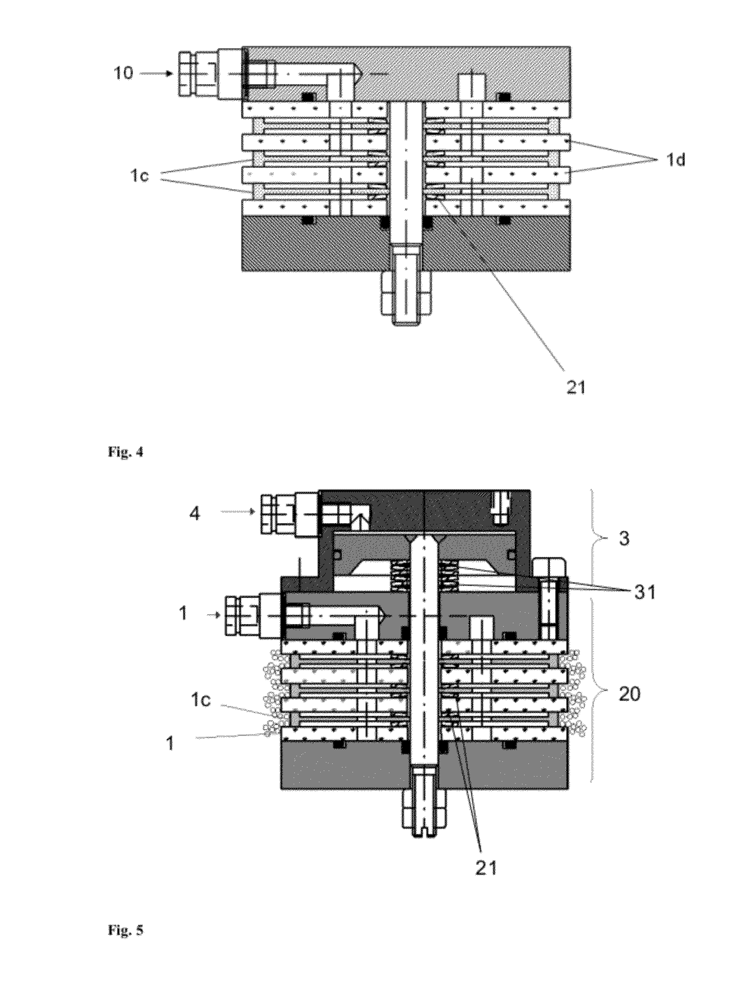

FIG. 4 schematically shows a preferred embodiment of FIG. 3, which is distinguished by an interior, centred threaded rod. From a construction point of view, this embodiment is simpler than the embodiment shown in FIG. 3 and it can be cleaned more easily as well. Furthermore, only one nut is required for clamping. However, this is qualified by individual clamping over the circumference of the annular discs using four different nuts as in FIG. 3 proving impossible should the clamping by the central nut lead to non-uniform gas efflux over the circumference.

FIG. 5 schematically shows a further preferred embodiment of a sparger according to the invention. In this embodiment, the sparger according to the invention comprises an integrated cleaning mechanism. The sparger comprises alternating annular discs (1c) and intermediate discs (1d). Microbubbles are created when the annular and intermediate discs are pressed onto one another with a defined surface pressure and gas is pressed through the gaps between the annular and intermediate discs created in the process.

Pressing these discs onto one another is, with the aid of a torque wrench, set by a nut situated on the lower part of the base body and transmitted to the discs via the cup springs 31. What is important here is that the cup springs 21 situated between the annular and intermediate discs are, as a result of their positioning in the cut-outs of the annular discs, less taut than the springs present in the upper part of the sparger. Hence the lower cup springs are only required for completely pressing the annular and intermediate discs onto one another. Thus, the lower six cup springs accordingly only raise a small force opposing the upper six cup springs.

During sparging the sparging air is only routed over the outer annulus of the annular discs, during which microbubbles are created.

The sparger has an integrated cleaning mechanism. In the process, control air pulses at 6 bar are put onto the stamp of the sparging element via the inlet (40). As a result, the stamp is lowered downwards. The cup springs 31 in the upper part of the sparger are compressed, not by tightening the nut but rather by the downwards motion of the stamp. Now the circumstances described above that the upper springs “trump” the lower springs in the cut-outs of the annular discs no longer hold true. The cup springs positioned in the cut-outs of the annular discs are unloaded and the applied disc pressure is reduced. As a result, the lower cup springs 21 uniformly press apart the annular and intermediate discs. This results in a gap which, as a result of the now increased air volume flow, makes it possible to clean the structure.

By way of example, the annular and intermediate discs may consist of high-grade steel, Teflon, PMMA and/or glass.

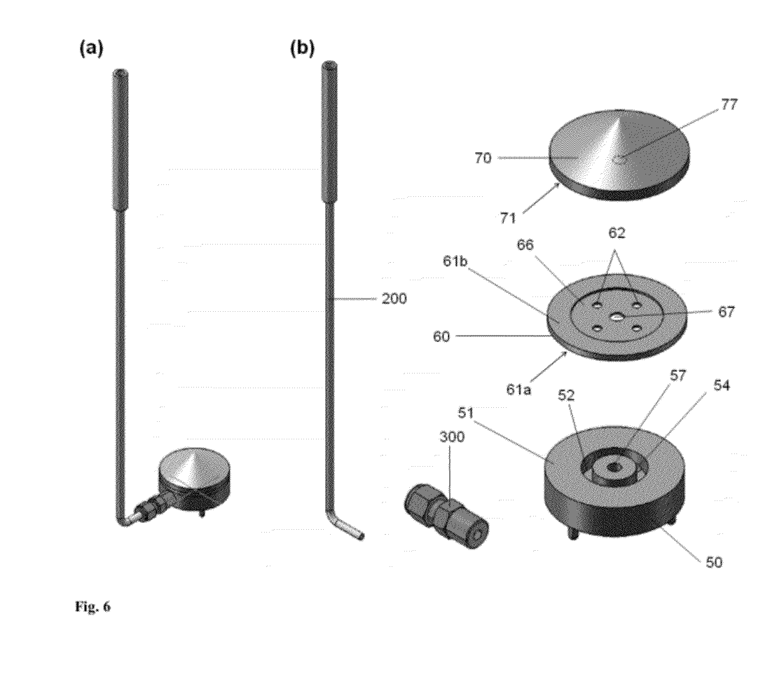

FIGS. 6(a) and (b) schematically show a further preferred embodiment of the sparger according to the invention. FIG. 6(a) shows the sparger in a perspective illustration. FIG. 6(b) shows the parts of the sparger of FIG. 6(a).

The sparger comprises a lower body 50, an intermediate disc 60 and a cover 70. The lower body 50 has a cavity 52 and a gas inlet 54. A gas or gas mixture can be pressed into the cavity 52 through the gas inlet 54. The gas inlet 54 is connected to a pipe 200 via a connecting piece 300. The pipe 200 is connected to a gas supply (not shown in the figure). The sparger according to the invention is embodied such that it can be immersed into a liquid, with the upper part of the pipe usually being situated above the level of the liquid.

The lower body of the sparger furthermore has a planar face 51, which can be brought into positive contact with the planar face 61a of the intermediate disc 60. The intermediate disc is symmetrical, and so it comprises a further planar face 61b, which can be brought into positive contact with a planar face 71 of the cover 70. As a result of the perspective view of the parts of FIG. 6(b), the faces 61a and 71 cannot be seen; they are respectively situated on the side of the parts facing away from the observer. They are therefore indicated by arrows.

The lower body 50, the intermediate disc 60 and the cover 70 are interconnected by means of a screw (not shown in the figure). The screw is routed from below through the feed through 57 of the lower body 60 and through the feed through 67 of the intermediate disc. The cover 70 has an opening 77 with a female thread into which the screw can be screwed. The opening 77 is situated on the side of the cover 70 facing away from the observer and hence it is not visible. It is marked by a dashed circle.

The screwed connection makes it possible to press the planar faces 51 and 61a, and also 61b and 71, onto one another. The intermediate disc 60 comprises a recessed region 66 into which openings 62 have been introduced. As a result of this, gas that was pressed into the cavity 52 through the gas inlet 54 also reaches the upper region of the sparger. If the aforementioned faces are pressed against one another by the screw and gas is pressed into the sparger through the gas inlet, said gas is distributed uniformly over the gaps between the faces. If the sparger is immersed into a liquid, bubbles, preferably microbubbles, are created in the liquid along the gaps over the circumference of the sparger.

FIGS. 7(a) and (b) show a further preferred embodiment of the sparger according to the invention in a perspective cross-sectional illustration. This embodiment is preferably embodied as a disposable article. The sparger comprises a lower plate 80 and an upper plate 100, which each comprise an annular planar face (81 and 101). FIG. 7(a) shows the upper and lower plates, before these are pressed onto one another in a planar and positive fashion. FIG. 7(b) shows the finished sparger. The upper and lower plates are pressed with the aid of a pressing tool 120. The lower plate has a recess; the upper plate has a feed through. A connection bolt 90 has been introduced into the recess and the feed through. By pressing the pressing tool onto the connection bolt the latter is deformed. As a result, upper plate, lower plate and connection bolt are deformed together and thus permanently connected. A homogeneous gap 95 is created between the faces 81 and 101 pressed onto one another in a positive fashion. Gas can be introduced into a liquid through same. Upper and lower plates have chamfers 82 and 102 with annular profiles. When the upper and lower plates are pressed onto one another, a channel 94 with an annular profile is created between the chamfers. Gas can be pressed into this channel 94 (cavity) via the interconnected channels 92 and 93. The channel 94 distributes gas over the entire gap length of the gap 95 with an annular profile. The connection bolt, which also acts as a gas inlet, has a male thread 98 and so a suitable gas supply can be connected to the sparger. Gas supply and cavity are sealed from the surroundings by means of an O-ring gasket.

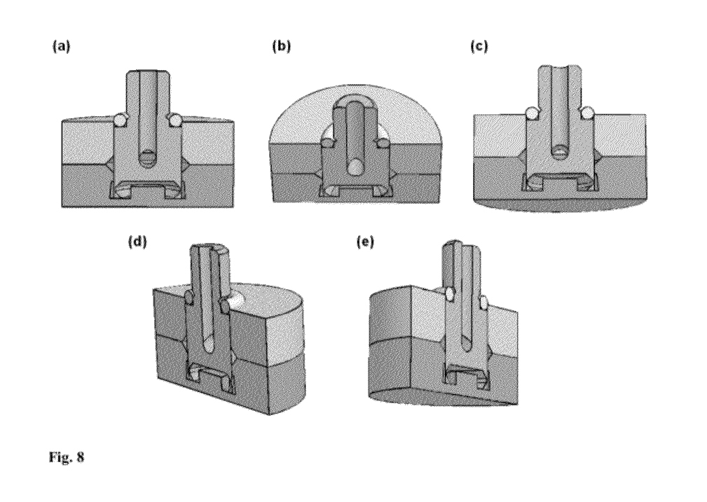

FIGS. 8(a)-(e) show the sparger according to the invention from FIGS. 7(a) and (b) in a perspective cross-sectional view from different observation angles.

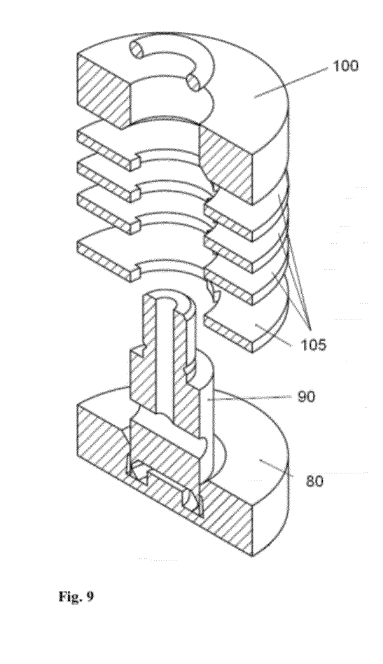

FIG. 9 shows a variant of the sparger shown in FIGS. 7 and 8. Here intermediate discs 105 have been introduced between the upper and lower plates. On their upper and lower sides, the intermediate discs have planar annular faces, which are pressed onto one another in a positive fashion. Hence this embodiment does not have an individual annular gap (as in the case of FIGS. 7 and 8), but five gaps, and so the amount of gas that can be introduced into a liquid is increased compared to the embodiment in FIGS. 7 and 8.

Parameter Selection for Setting an Optimum Operating Point

The following trials were carried out using the sparger shown in FIG. 5. Different annular discs with an external bead and different intermediate-disc materials were available. The annular discs consisted of high-grade steel (VA 1.4571) and had a surface roughness of Ra=0.4 μm. Annular discs were tested with annular widths of 2 mm, 5 mm to 10 mm. Discs made of Teflon, PMMA, glass and polished VA (Ra=0.08 μm) were used as intermediate discs.

The quality of the sparging system was established by determining the volume-specific mass transport coefficient as a measure for the speed of the mass transport from the gaseous and into the liquid phase, which is referred to as k_{L}a value below.

The change in the concentration c of a gas dissolved in a liquid over time t can be described with the aid of the following relationship:

$$\frac{d c}{d t} = {k}_{L} a \cdot ( {c}^{*} - c ) \qquad ( 1 )$$

The following emerges after solving the differential equation with the boundaries c₀ and c, and 0 and t:

$$ln ( \frac{{c}^{*} - c}{{c}^{*} - {c}_{0}} ) = - {k}_{L} a \cdot t \qquad ( 2 )$$

Here c* corresponds to the maximum and c corresponds to the current dissolved gas concentration. The gas concentration at the start of the measurement is described by c₀.

If the quotient (c*−c)/(c*−c₀) is now plotted logarithmically over time t, this results in a straight line, the negative gradient of which corresponds to the k_{L}a value.

The temperature dependence of the volume-specific mass transport coefficient is taken into account by converting all k_{L}a values to a temperature of 20° C. using Judat's formula (3):

k_{L}a_{293K}=k_{L}a_{T}·1.024^{(293K-T)} (3)

Here, the temperature T corresponds to the temperature in K prevalent during the measurement. The volume flows were also converted to an absolute pressure of 1 bar:

$${\dot{V}}_{1 bar} = {\dot{V}}_{Rotameter} \cdot \sqrt{1 + \frac{Δ p}{{p}_{0}}} \qquad ( 4 )$$

V_{Rotameter} corresponds to the volume flow read out on a rotameter. The overpressure in the gas line is specified by Δp and p₀ corresponded to 1 bar.

A container with a liquid volume of 2.81 was selected for the measurements. The sparger was positioned approximately 2 cm above the container base with the aid of threaded rods.

There was a 6-paddle disc agitator over the sparger. Said disc agitator was operated with a rotational speed of 250 rpm, which corresponds to a volume-specific power input of 78 W/m³. This power input is greater than the power input usually used for cultivating cell lines. However, this power input was necessary because bubbles could only be prevented from adhering on the oxygen electrode positioned obliquely thereabove at and above the selected rotational speed as a result of the strong inflow. Moreover, there was no thrombus formation.

Pressure or volume flow of the gas for sparging the liquid could be set by means of a needle valve and be established by means of an appropriate manometer/rotameter. Here, an upstream pressure reducing valve ensured that an overpressure of 2.5 bar is not exceeded.

The control air for the cleaning mechanism at 6 bar overpressure was routed directly into the sparger.

Oxygen was used as gas for sparging the liquid. The increasing oxygen concentration in a liquid medium was recorded until constancy in the values was reached. The measurement was conducted with the aid of an oxygen electrode (CellOx 325 by WTW) and a portable oxygen measuring instrument (Oxid 197i by WTW). The data was recorded (every second or every 5 seconds) using an Almemo 2290-8 V5 (by AMR).

The trials were carried out in an aqueous medium, which was composed as follows:
9 g/L NaCl SIGMA-Aldrich Chemie GmbH, Steinheim, Germany
2 g/L NaHCO₃ KMF Laborchemie Handels GmbH, Lohmar, Germany
1 g/L Pluronic F68 SIGMA-Aldrich Chemie GmbH, Steinheim, Germany
10 ppm Antifoam C SIGMA Chemical Company, St. Louis, Mo., USA

In order to set an optimum operating point, a torque was firstly set at which optically small bubbles were created. Then measurements were performed at different overpressures. Then the VA-annular disc widths were varied, and finally the intermediate disc materials as well.

During the experiments it was possible to determine that it was necessary to set a torque of 7 Nm in order to be able to create microbubbles using the sparger. In the process, differences in the nature of the bubbles could already be determined purely by looking at them when using different intermediate disc materials. Thus, if Teflon discs are used it is possible to observe non-uniform bubble formation over the circumference. At the same time, the created bubbles also have greatly varying sizes. However, if the Teflon discs are replaced by VA discs, polished on one side, it is possible to determine uniform bubble formation over the circumference. Moreover, the bubbles vary less strongly in terms of their diameter. These differences, which can already be identified by merely looking at them, are also reflected in the established k_{L}a values (see Table 1).

Tables 1 and 2 provide an overview of the k_{L}a values in [1/h] established in the case of different material combinations. These were, with the aid of Judat's formula (3), converted to a temperature of 20° C. and were established at an overpressure of 2.5 bar. The volume flows (in [1/h]) read off during the measurement and converted to 1 bar can in each case be found behind the corresponding k_{L}a value.

TABLE 1
Overview of k_{L}a values [l/h] established in the case of different material combinations.

| | | | k_{L}a value [l/h] | k_{L}a value [l/h] |
|---|---|---|---|---|
| Width of the | | k_{L}a value [l/h] | (Volume flow [l/h]) | (Volume flow [l/h]) |
| annulus of | | (Volume flow [l/h]) | for an intermediate | for an intermediate |
| the annular | | for an intermediate | disc made of Teflon | disc made of Teflon |
| disc VA | Torque | disc made | (central), VA polished on | (central), glass |
| [mm] | [Nm] | of Teflon | one side (outside) | (outside) |
| 2 | 7 | 12 (26.4)-14 (6) | 54 (30.7)-56 (30.7) | |
| | 10 | 15 (0.6)-18 (24.3) | 42 (16.3)-61 (30.7) | |
| 5 | 7 | 3 (3.9)-20 (16.1) | 29 (11.6)-40 (17.2) | 65 (30.7)-69 (30.7) |
| | 10 | 2 (4.7)-11 (4.9) | 20 (9.0)-24 (10.3) | 37 (9.7) |
| | 15 | 2 (4.1)-3 (5.2) | 17 (8.6)-18 (6.0) | |
| 10 | 7 | 3 (2.6; 4.9) | 35 (15.2)-39 (15.2) | |
| | 10 | 2 (4.5; 5.2) | 18 (5.8)-29 (12.0) | |

The k_{L}a values have been converted to a temperature of 20° C. and established at 2.5 bar overpressure (bar gauge). The volume flows in parentheses in [l/h] have been converted to an absolute pressure of 1 bar.

TABLE 2
Overview of k_{L}a values [l/h] established in the case
of VA intermediate discs polished on both sides.

| Width of the | | | |
|---|---|---|---|
| annulus of | | Measurement at | Measurement at |
| the annular | Torque | 1 bar | 2.5 bar |
| disc VA [mm] | [Nm] | overpressure | overpressure |
| 5 | 7 | 51 (63.1)-52 (23.7) | 69 (218.1)-72 (187.5) |
| | 10 | 48 (47.4)-53 (24.3) | 66 (109.3)-68 (57.1) |
| 10 | 7 | 32 (12.6)-38 (11.9) | 73 (44.7)-80 (59.7) |
| | 10 | 28 (8.2)-36 (9.3) | 51 (35)-66 (39.8) |

The k_{L}a values have been converted to a temperature of 20° C.; the volume flows in parentheses [l/h] have been converted to an absolute pressure of 1 bar.

The k_{L}a value is influenced by the following parameters:
Set torque
Gas pressure or volume flow
Intermediate disc material and surface properties
Width of the annulus

Different additional rules could be derived during the measurements. Thus, it was possible to determine that measurements carried out at an overpressure of 2.5 bar supplied greater k_{L}a values than experiments at 1 bar overpressure. This can be traced back to the greater volume flows connected to a higher system pressure. Moreover, it was possible to observe that as the annular disc width and the torque increased the k_{L}a values and volume flows dropped. In both cases a greater system pressure is required to press the sparging air through the broadening annuli or the annuli lying on one another more securely. However, if a constant system pressure is now maintained, it follows that k_{L}a values and volume flows must necessarily drop. Overall it is possible to determine that the k_{L}a values established with the VA intermediate discs polished on both sides (up to 80 h⁻¹) are very high.

Moreover, the diameters of the bubbles produced by the sparger were established. In order to determine bubble sizes by means of laser scattering, use was made of a Lasentec probe (Model FBRM D600 L-HC-K, Laser Sensor Technology, Redmond, Wash., USA with associated software Lasentec FBRM Acquisition 500-600 and Lasentec FBRM Data Review).

Dependent on the operating point and the agitator rotational speed, it was possible to determine median values (arithmetic mean of at least 15 measurement points) of between 21 μm and 55 μm bubble diameter in the case of VA intermediate discs polished on both sides. Overall, the following tendencies could be observed:
The median values increase with increasing agitator rotational speed.
There are greater bubble diameters in the case of 2.5 bar overpressure than in the case of an overpressure of 1 bar.
Smaller median values are obtained at higher torques (10 Nm).
The median values measured with the 10 mm annular disc are smaller than the values established with the 5 mm disc.

It is possible to determine that a greater volume flow (in the case of measurements with 2.5 bar overpressure, torque of 7 Nm or 5 mm annular disc) is connected to larger bubble diameters.

1. A liquid sparger at least comprising a cavity, a gas inlet for routing a gas into the cavity and two or more faces, which are or can be pressed onto one another in a positive fashion, wherein said liquid sparger is embodied such that a gas pressed into said cavity through said gas inlet escapes through gaps occurring between pressed together faces of said sparger.

2. The liquid sparger according to claim 1, wherein said faces are provided by windings of a helical spring.

3. The liquid sparger according to claim 1, wherein said faces are provided by annular discs.

4. The liquid sparger according to claim 1, wherein said faces pressed onto one another can, for cleaning purposes, be detached from another in an impulsive fashion by an external force.

5. The liquid sparger according to claim 1, wherein said liquid sparger is embodied as a disposable article.

6. The liquid sparger according to claim 1, capable of being used for sparging culture media.

7. A method for sparging liquids, comprising routing a gas or gas mixture between two or more faces pressed onto one another in a positive fashion and introducing said gas or gas mixture into a liquid via gaps between the faces.

8. The method according to claim 7, wherein said gas or gas mixture comprises bubbles that have a diameter of less than 1 mm, optionally of less than 200 μm.

9. The method according to claim 8, wherein the bubbles have a diameter in the range of from 10 μm to 80 μm, optionally from 20 μm to 60 μm.
